(19) United States
(12) Patent Application Publication
(10) Pub. No.: US 2015/0117969 A1
(43) Pub. Date: Apr. 30, 2015

(54) CUTTING INSERT AND SHIM FOR HEAVY MACHINING OPERATIONS

(71) Applicant: Kennametal Inc., Latrobe, PA (US)

(72) Inventors: Lance David Brunetto, Greensburg, PA (US); Jeffrey Francis Kovac, Loyalhanna, PA (US)

(73) Assignee: Kennametal Inc., Latrobe, PA (US)

(21) Appl. No.: 14/065,914

(22) Filed: Oct. 29, 2013

(51) Int. Cl. B23C 5/24; B23C 5/20

(52) U.S. Cl. CPC B23C 5/2475; B23C 5/207; B23C 2200/128; B23C 2210/166
USPC 407/42; 407/113

(57) ABSTRACT

A combination of a cutting insert and a shim. The cutting insert and shim have two opposing end surfaces, two identical opposing major side surfaces and two identical opposing minor side surfaces. Each end surface of the insert has a shim abutment surface for contacting the shim. One end surface of the shim has an insert abutment surface for contacting the insert. The abutment surfaces contact each other along an entire length of the cutting insert and shim so as to help distribute the loads encountered in the cutting operation, as well as provide protection of the insert pocket in case of insert failure.

### FIELD OF THE INVENTION

In general, the invention relates to a cutting insert and a cutting tool, and in particular to a cutting insert for a milling cutter that contact with each other in an area where high cutting forces occur so as to help distribute the loads (stresses) encountered in the cutting operation, as well as provide protection of the insert pocket in case of insert failure.

### BACKGROUND OF THE INVENTION

One problem encountered with conventional tool holders is that of holding the cutting insert securely in the pocket of the tool holder. At the beginning of a cutting operation, the sudden transition from no load to extreme pressure load on the insert can cause the insert to shift position in the holder and thereby affect the accuracy of the planned cut. At the end of the cutting operation, the sudden disengagement of the cutting insert from the workpiece causes the pressure load suddenly to be removed from the insert. This sudden change in load can cause the insert to shift and distress any repeatable dimensional accuracy, which is essential for most tool holders, especially cutting inserts used in Numerically Controlled machines, to meet.

During the cutting operation, loads of up to 35,000 pounds may be encountered on the cutting insert which, if the insert is not precisely located and firmly held in the holder to begin with, can also cause shifting of the insert during the cutting operation. It is, therefore, important to provide a tool holder that can precisely and securely seat a cutting insert and then securely hold the cutting insert in location during all phases of the heavy duty cutting operation.

### SUMMARY OF THE INVENTION

In one aspect of the invention, a cutting insert comprises two opposing end surfaces, two opposing minor side surfaces extending between the two opposing end surfaces, and two opposing major side surfaces extending between the end surfaces and the minor side surfaces. Each end surface has four corners including two lowered corners and two raised corners. The two lowered corners are diagonally opposite each other, and the two raised corners are diagonally opposite each other. The cutting insert further includes two opposing major edges formed at an intersection of each end surface and the major side surfaces, two opposing minor edges formed at an intersection of each end surface and the minor side surfaces, and two opposing corner edges formed at an intersection of each the corner side surfaces and the major side surfaces. The cutting insert further includes a major cutting edge formed at an intersection of each major edge and the end surface, and a minor cutting edge formed at an intersection of each minor edge and the end surface, and a corner cutting edge formed at an intersection of the major and minor cutting edges. Each end surface includes a shim abutment surface that extends from one lowered corner to the diagonally opposite lowered corner.

In another aspect, a combination cutting insert and a shim for heavy machining operations. The cutting insert comprises two opposing end surfaces, two opposing minor side surfaces extending between the two opposing end surfaces, and two opposing major side surfaces extending between the end surfaces and the minor side surfaces. Each end surface has four corners including two lowered corners and two raised corners. The two lowered corners are diagonally opposite each other, and the two raised corners are diagonally opposite each other. Each end surface includes a shim abutment surface that extends from one lowered corner to the diagonally opposite lowered corner. The shim comprises two opposing end surfaces, two opposing minor side surfaces extending between the two opposing end surfaces. Two opposing major side surfaces extend between the end surfaces and the minor side surfaces. One end surface has four corners comprising two lowered corners and two raised corners. The two lowered corners are diagonally opposite each other, and the two raised corners are diagonally opposite each other. One of the end surfaces of the shim has an insert abutment surface that extends entirely from one raised corner to the diagonally opposite raised corner of the shim for contacting the shim abutment surface of the cutting insert.

In another aspect, a milling cutter comprises a plurality of insert pockets, wherein the cutting insert and the shim of the invention are seated in each of the plurality of insert pockets.

### BRIEF DESCRIPTION OF THE DRAWINGS

While various embodiments of the invention are illustrated, the particular embodiments shown should not be construed to limit the claims. It is anticipated that various changes and modifications may be made without departing from the scope of this invention.

FIG. 1 is an isometric view of an exemplary embodiment of a cutting insert of the invention;

FIG. 2 is an end view of the exemplary embodiment of the cutting insert of FIG. 1;

FIG. 3 is a top view of the exemplary embodiment of the cutting insert of FIG. 1;

FIG. 4 is a front view of the exemplary embodiment of the cutting insert of FIG. 1;

FIG. 5 is a cross-sectional view of the exemplary embodiment of the cutting insert taken along line 5-5 of FIG. 3;

FIG. 6 is a cross-sectional view of the exemplary embodiment of the cutting insert taken along line 6-6 of FIG. 3;

FIG. 7 is an isometric view of an exemplary embodiment of a shim of the invention;

FIG. 8 is another isometric view of an exemplary embodiment of the shim of FIG. 7;

FIG. 9 is an end view of the exemplary embodiment of the shim of FIG. 7;

FIG. 10 is another end view of the exemplary embodiment of the shim of FIG. 7;

FIG. 11 is a side view of the exemplary embodiment of the shim of FIG. 7;

FIG. 12 is a cross-sectional view of an exemplary embodiment of the cutting insert and the shim; and

FIG. 13 is an isometric view of an exemplary embodiment of a milling cutter with the combination cutting insert and shim seating in insert pockets.

### DETAILED DESCRIPTION OF THE INVENTION

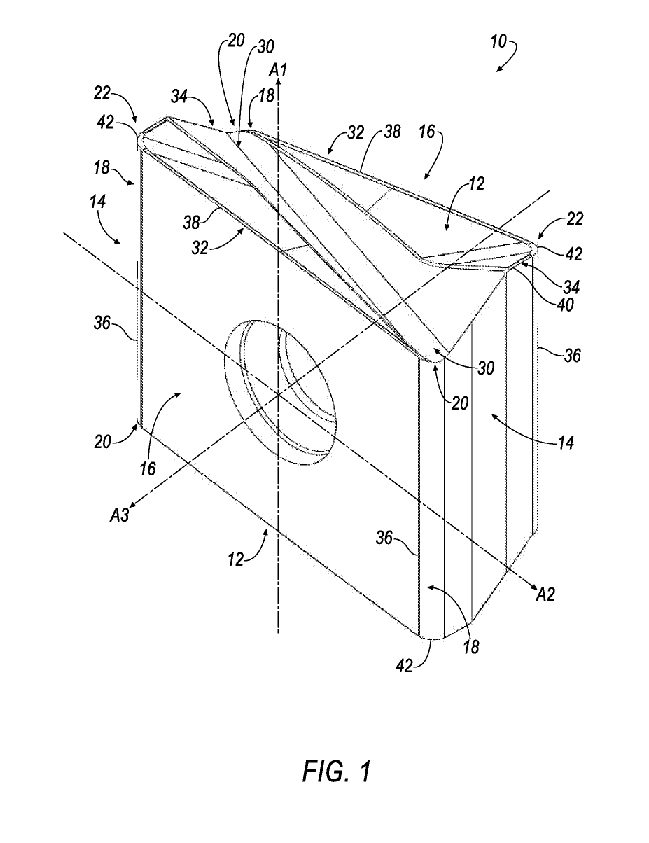

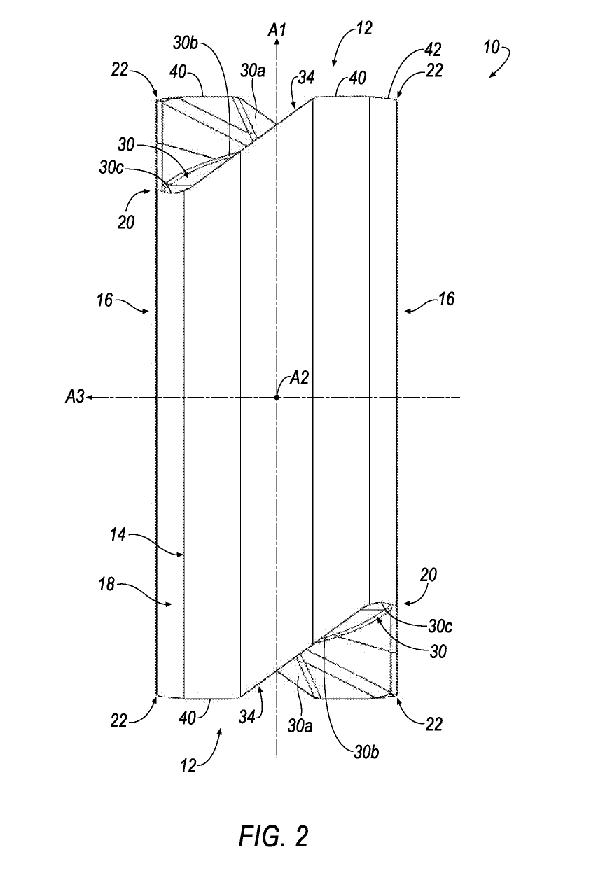

Referring now to FIGS. 1-6, a cutting insert 10 is shown according to an embodiment of the invention. In general, the cutting insert 10 is tangential and indexable. The cutting insert 10 is typically manufactured by form-pressing and sintering carbide powders using methods well-known in the art. The cutting insert 10 is generally rectangular in shape and has two identical opposing end surfaces 12, two identical opposing minor side surfaces 14 extending between the two opposing end surfaces 12, two identical opposing major side surfaces 16 extending between the end surfaces 12 and the minor side surfaces 14. Each end surface 12 has 180° rotational symmetry about a first central axis A1 passing through the two end surfaces 12, each minor side surface 14 has 180° rotational symmetry about a second central axis A2 passing through the two minor side surfaces 14, and each major side surface 16 has 180° rotational symmetry about a third central axis A3 passing through the two major side surfaces 16. The second central axis A2 is perpendicular to the first central axis A1, and the third central axis A3 is perpendicular to the first central axis A1 and to the second central axis A2. The cutting insert 10 also includes four opposed corner side surfaces 18 between the minor and major side surfaces 14, 16 and the end surfaces 12.

Each end surface 12 has four corners; two diagonally opposite lowered corners 20 and two diagonally opposite raised corners 22. The lowered corners 20 are closer to the second central axis A2 than the raised corners 22. Each corner side surface 18 extends between the raised corner 22 of one of the two opposing end surfaces 12 and the lowered corner 20 of the other one of the two opposing end surfaces 12.

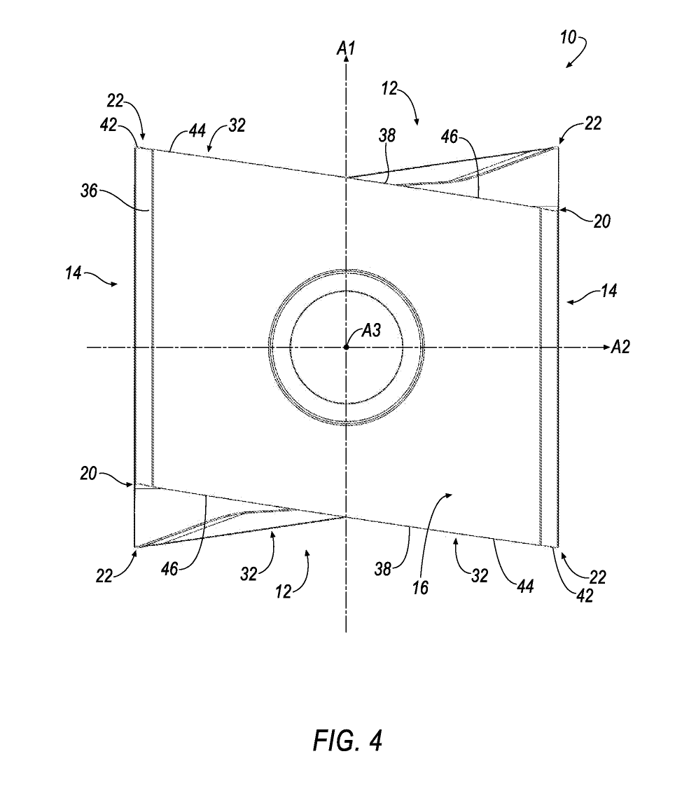

Two opposing major edges 32 are formed at the intersection of each end surface 12 and the major side surfaces 16, two opposing minor edges 34 are formed at the intersection of each end surface 12 and the minor side surfaces 14, and two opposing corner edges 36 are formed at the intersection of each the corner side surfaces 18 and the major side surfaces 16. A major cutting edge 38 is formed at the intersection of each major edge 32 and the end surface 12 and extends along substantially the entire length of its associated major edge 32. A minor cutting edge 40 is formed at the intersection of each minor edge 34 and the end surface 14 and extends along its associated minor edge 34. A corner cutting edge 42 is formed at the intersection of the major and minor cutting edges 38, 40. The section of the major cutting edge 38 proximate the raised corner 22 constitutes a leading end 44 of the major cutting edge 38, whereas the section of the major cutting edge 38 proximate the lowered corner 20 constitutes a trailing end 46 of the major cutting edge 38, as shown in FIG. 4. Because the cutting insert 10 is symmetric about all three axes, A1, A2 and A3, the cutting insert 10 has a total of four major cutting edges 38, four minor cutting edges 40 and four corner cutting edges 42.

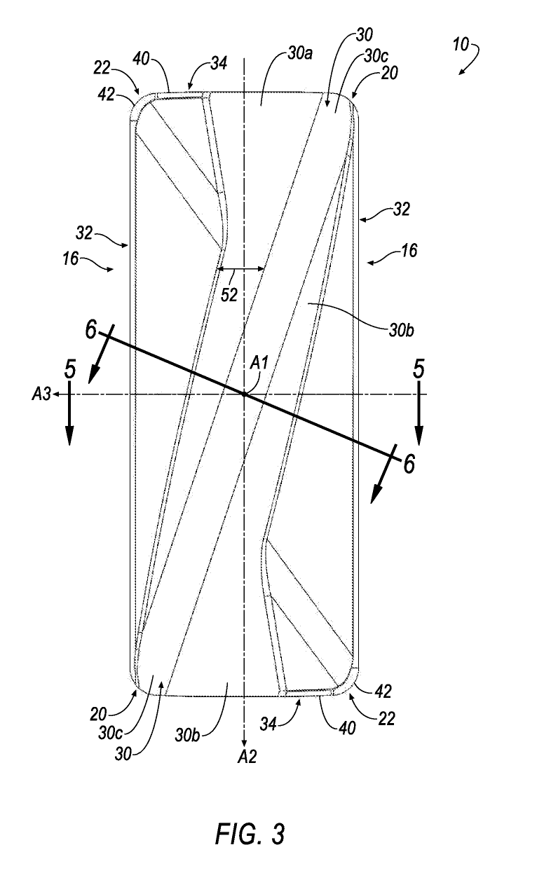

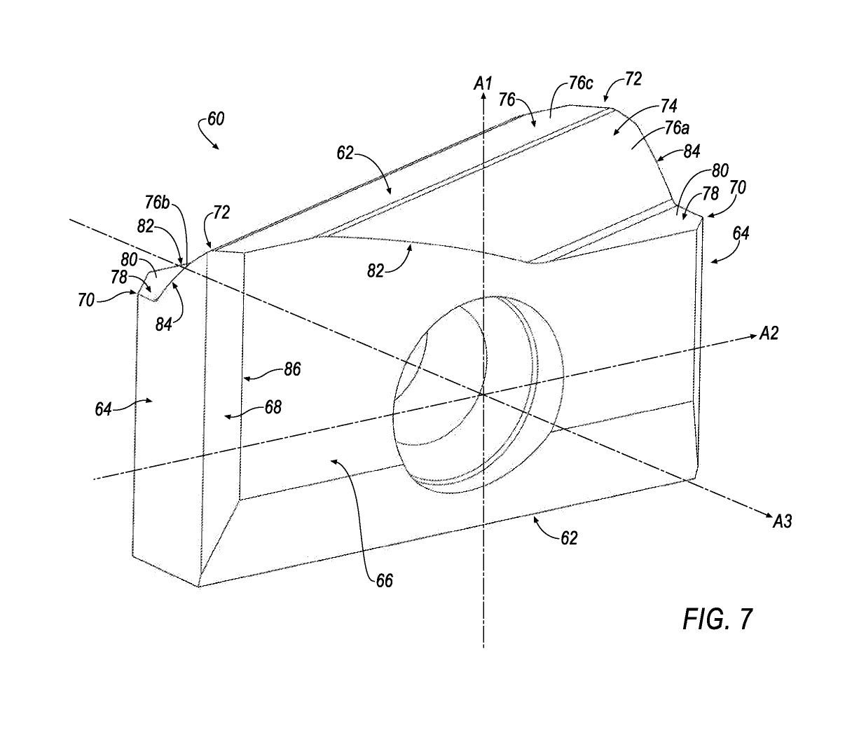

Referring now to FIGS. 3, 5 and 6, one aspect of the invention is that each end surface 12 of the cutting insert 10 has a shim abutment surface 30 for contacting a shim 60 (FIG. 7) that extends entirely from one lowered corner 20 to the diagonally opposite lowered corner 20 of the cutting insert 10. In the illustrated embodiment, the shim abutment surface 30 is in the form of a U-shaped groove having side support walls 30a, 30b, and a bottom wall 30c formed between the two side support walls 30a, 30b with a radius R. The two side support walls 30a, 30b extend from the bottom wall 30c to the surface 26 of each raised member 24, as shown in FIG. 3.

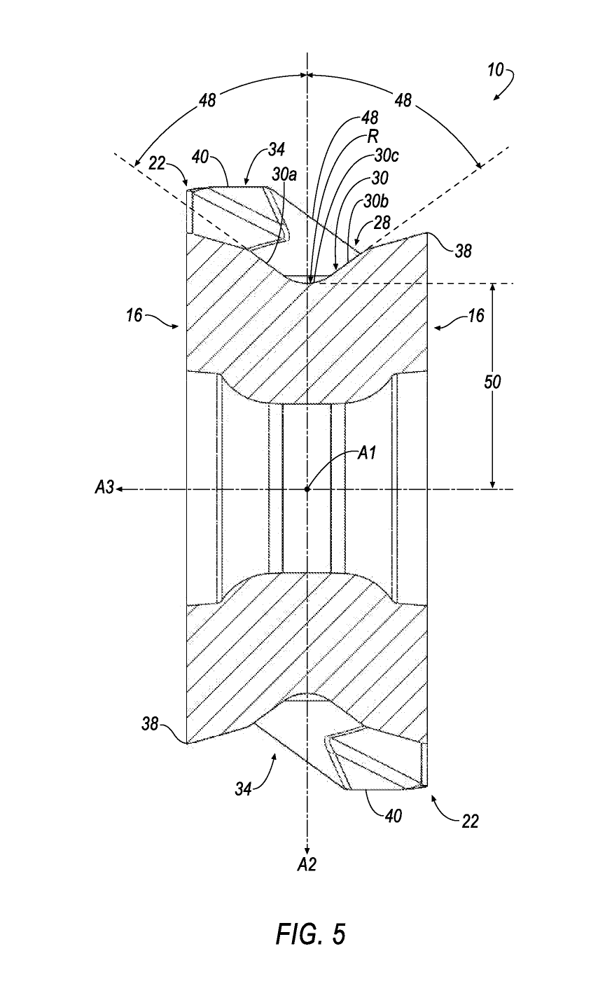

As shown in FIG. 5, the two side support walls 30a, 30b are formed at an angle 48 with respect to the second central axis A2. That is, the two side support walls 30a, 30b are non-parallel to the third central axis A3 of the cutting insert 10, unlike conventional cutting inserts. The angle 48 can be greater than zero (0) degrees and less than ninety (90) degrees. In the illustrated embodiment, the angle 48 is about sixty (60) degrees. However, it will be appreciated that the invention is not limited by the magnitude of the angle 48, and that the invention can be practiced with any desirable angle between the two side support walls 30a, 30b to provide sufficient contact between the insert 10 and the shim 60. In an alternate embodiment, the radiused bottom wall 30c can be omitted and the abutment surface 30 can have a substantially V-shaped profile with only the side supports surfaces 30a, 30b, rather than a substantially U-shaped profile of the illustrated embodiment.

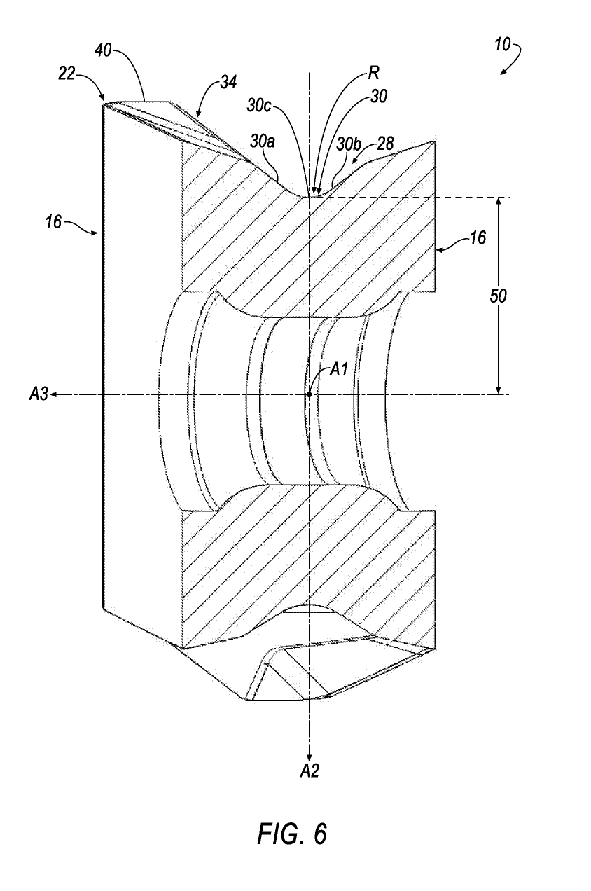

As shown in FIGS. 5 and 6, a distance 50 between the bottom wall 30c and the third central axis A3 remains constant across the entire length of the abutment surface 30. In other words, the bottom wall 30c of the shim abutment surface 30 is substantially coplanar along its entire length from one lowered corner 20 to the diagonally opposite lowered corner 20.

As shown in FIG. 3, the bottom wall 30c has a substantially constant width along its entire length from one lowered corner 20 to the diagonally opposite lowered corner 20. On the other hand, the side support walls 30a, 30b have a continuously varying width 52 along their entire length from one lowered corner 20 to the diagonally opposite lowered corner 20. Specifically, the width 52 of the side support walls 30a, 30b are inversely proportional to each other. For example, the width of the side support wall 30a is a minimum, while the width 52 of the side support wall 30b is a maximum at the lowered corner 20, and the width 52 of the side support wall 30a is a maximum, while the width 52 of the side support wall 30b is a minimum at the diagonally opposite lowered corner 20. It is noted that the width 52 of each side support wall 30a, 30b is approximately equal to each other at a point where the first central axis A1 and the third central axis A3 intersect each other, as shown in FIG. 3.

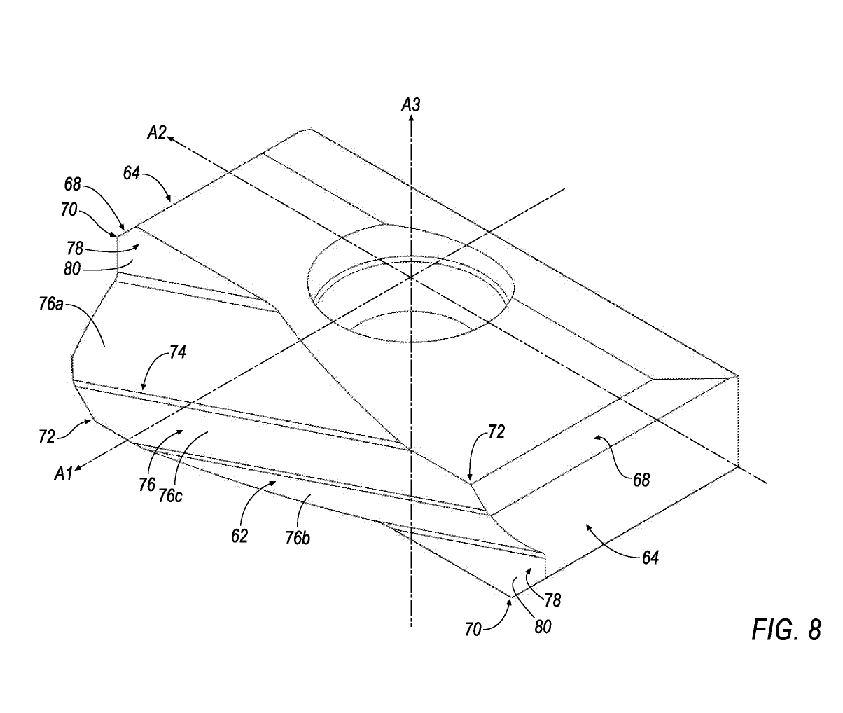

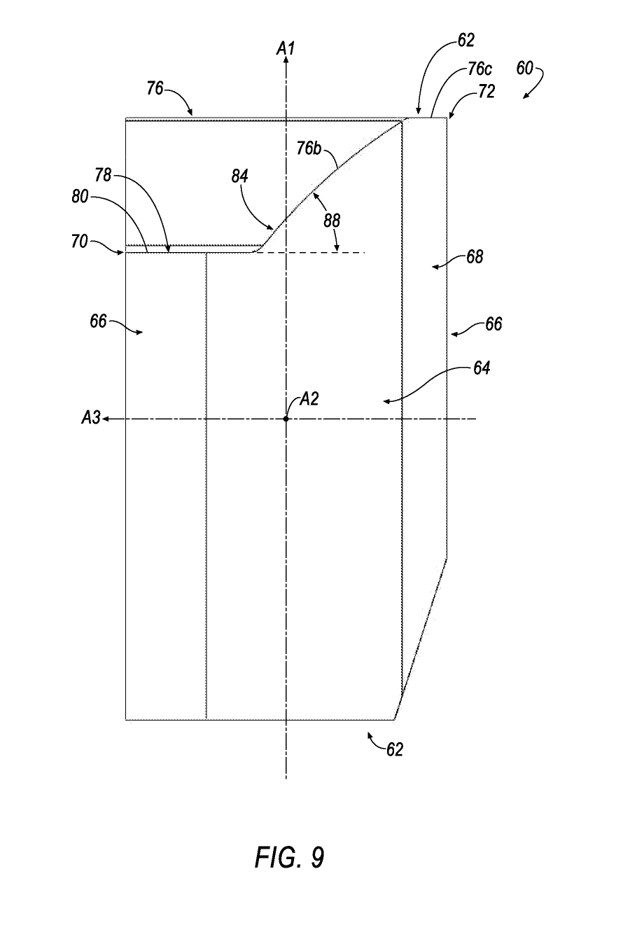

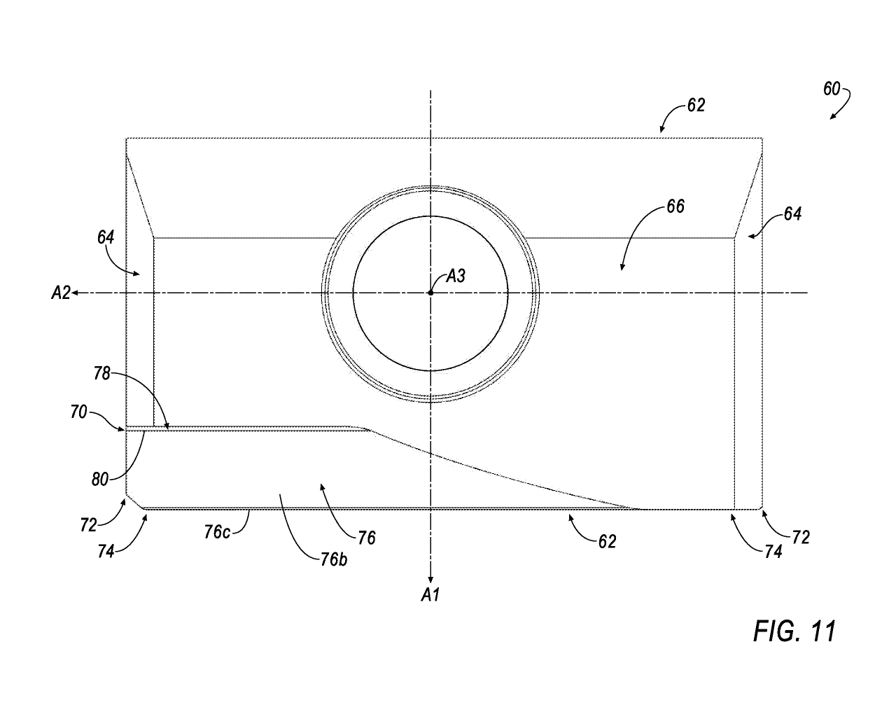

Referring now to FIGS. 7-11, a shim 60 is shown according to an embodiment of the invention. In general, the shim 60 is generally rectangular in shape and has two opposing end surfaces 62, two identical opposing minor side surfaces 64 extending between the two opposing end surfaces 62, two identical opposing major side surfaces 66 extending between the end surfaces 62 and the minor side surfaces 64. Each minor side surface 64 is asymmetric about a second central axis A2 passing through the two minor side surfaces 64, and each major side surface 66 has 180° rotational symmetry about a third central axis A3 passing through the two major side surfaces 66. The second central axis A2 is perpendicular to the first central axis A1, and the third central axis A3 is perpendicular to the first central axis A1 and to the second central axis A2. The cutting insert 10 also includes four opposed corner side surfaces 68 between the minor and major side surfaces 64, 66 and the end surfaces 62.

Similar to the cutting insert 10, one of the end surfaces 62 has four corners; two diagonally opposite lowered corners 70 and two diagonally opposite raised corners 72. Unlike the cutting insert 10, the other end surface 62 is substantially planar for engaging the rear wall of the insert pocket, as described below. The lowered corners 70 are closer to the second central axis A2 than the raised corners 72. Each corner side surface 68 extends between the raised corner 72 of one of the two opposing end surfaces 62 and the lowered corner 70 of the other one of the two opposing end surfaces 62. One of the end surfaces 62 is provided with a raised abutment member 74 having an insert abutment surface 76 for contacting the insert 10, and two lowered members 78, each lowered member 78 having a surface 80. The insert abutment surface 76 extends entirely from one raised corner 72 to the diagonally opposite raised corner 72 of the shim 60. As seen in FIG. 7, the insert abutment surface 76 is planar and perpendicular to the first central axis A1, and parallel to both the second central axis A2 and the third central axis A3.

Two opposing major edges 82 are formed at the intersection of each end surface 62 and the major side surfaces 66, two opposing minor edges 84 are formed at the intersection of each end surface 62 and the minor side surfaces 64, and two opposing corner edges 86 are formed at the intersection of each the corner side surfaces 68 and the major side surfaces 66.

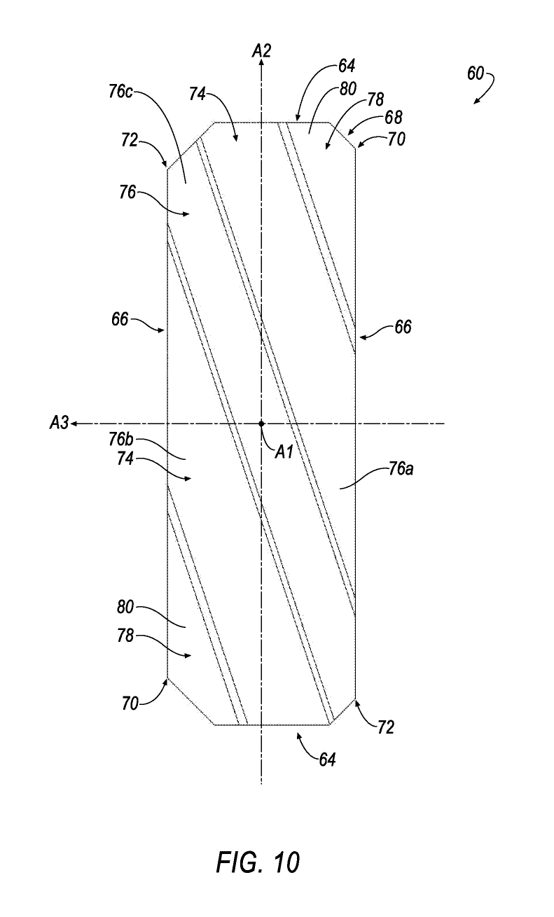

As shown in FIG. 10, another aspect of the invention is that one of the end surfaces 62 of the shim 60 has an insert abutment surface 76 that extends entirely from one raised corner 72 to the diagonally opposite raised corner 72 of the shim 60 for contacting the shim abutment surface 30 of the cutting insert 10. In the illustrated embodiment, the insert abutment surface 76 is in the form of a U-shaped protrusion having substantially planar side support walls 76a, 76b, and a substantially planar top wall 76c formed between the two side support walls 76a, 76b. The two side support walls 76a, 76b extend from the top wall 76c to the surface 80 of each lowered member 78, as shown in FIG. 10.

As shown in FIGS. 7, 9 and 10, the two side support walls 76a, 76b are formed at an angle 88 with respect to the second central axis A2. That is, the two side support walls 76a, 76b are non-parallel to the second central axis A2 of the shim 60, unlike conventional shims. The angle 88 can be greater than zero (0) degrees and less than ninety (90) degrees. In the illustrated embodiment, the angle 88 is about sixty (60) degrees. However, it will be appreciated that the invention is not limited by the magnitude of the angle 88, and that the invention can be practiced with any desirable angle between the two side support walls 76a, 76b to provide sufficient contact between the insert 10 and the shim 60. In one embodiment, the angle 88 is approximately equal to the angle 52 of the side support walls 30a, 30b of the shim abutment surface 30 of the cutting insert 10. Similar to the bottom wall 30c of the shim abutment surface 30, the top wall 76c of the insert abutment surface 76 has a constant width.

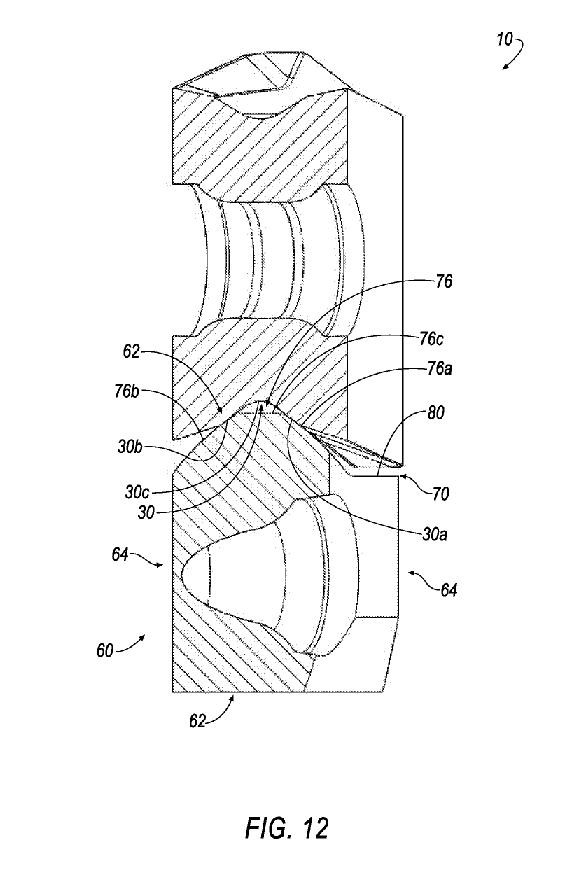

Referring now to FIG. 12, the insert 10 and the shim 60 interact with each other to provide additional support to permit proper seating and reduce rotation of the cutting insert 10 during heavy machining applications, as compared to conventional cutting inserts and shims. Specifically, the side support walls 30a, 30b of the shim abutment surface 30 of the cutting insert 10 engage the side support walls 76a, 76b of the insert abutment surface 76 of the shim 60 along the entire length of the cutting insert 10 and the shim 60, thereby increasing the contact area between the cutting insert 10 and the shim 60. It is noted that the bottom surface 30c of the shim abutment surface 30 of the cutting insert 10 does not contact the top surface 76c of the insert abutment surface 76 of the shim 60. In addition, the diagonal opposite engagement of the cutting insert 10 and the shim 60 along the entire length aids in centering the cutting insert 10 with respect to the shim 60. Further, the large contact area between the cutting insert 10 and the shim 60 is located in an area where high cutting forces occur during heavy machining applications. Because the cutting insert 10 and the shim 60 contact each other in the area where high cutting forces (and high stress) occur, additional support to permit proper seating and reduced rotation of the cutting insert 10 is provided by the cutting insert 10 and shim 60 of the invention.

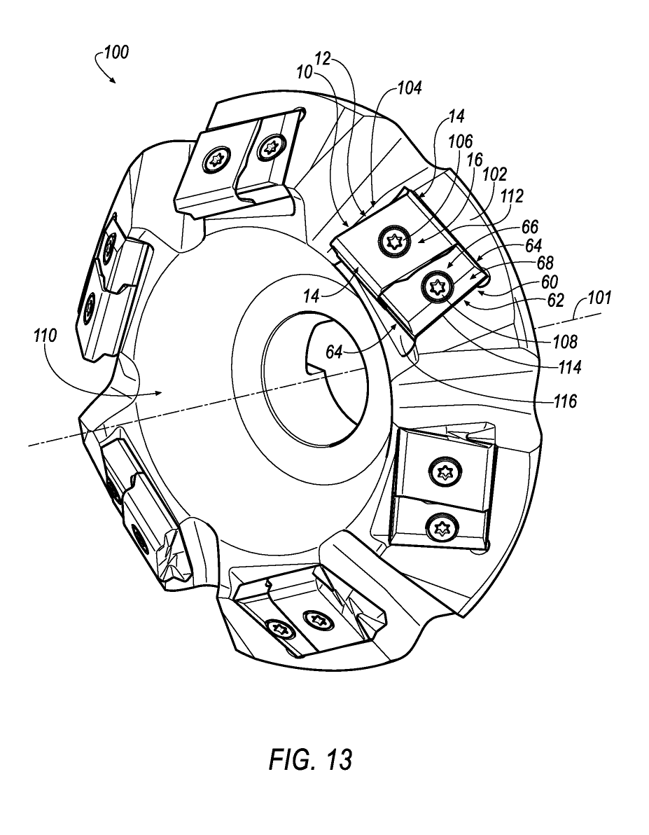

Referring now to FIG. 13, a milling cutter 100 is shown according to an embodiment of the invention. The milling cutter 100 has an axis of rotation 101, and a cutter body 102 with a plurality of insert pockets 104. In each insert pocket 104, the cutting insert 10 and the shim 60 of the invention is tangentially mounted to the cutter body 102 by means of a clamping screw 106, 108, respectively. As can be seen, each cutting insert 10 is seated so that there is a clearance between a workpiece (not shown) and the minor side surface 14 of the cutting insert 10, the minor side surface 64 of the shim 60 and the face 110 of the milling cutter 100.

The insert pocket 104 includes a side wall 112 and a rear wall 114 generally transverse to a bottom wall 116. Each wall 112, 114, 116 is generally planar. When seated in the insert pocket 104, one of the minor side surfaces 14 of the cutting insert 10 is adjacent and engages the side wall 112, and one of the major side surfaces 16 of the cutting inset 10 is adjacent and engages the bottom wall 116 of the insert pocket 104. Similarly, one of the minor side surface 64 of the shim 60 is adjacent and engages the side wall 112, and one of the major side surfaces 66 of the shim 60 is adjacent and engages the bottom wall 116 of the insert pocket 104. In addition, the shim abutment surface 36 on the end surface 12 of the cutting insert 10 engages the insert abutment surface 76 of the shim 60 to permit proper seating and reduced rotation of the cutting insert 10 during heavy machining operations.

The patents and publications referred to herein are hereby incorporated by reference.

Having described presently preferred embodiments the invention may be otherwise embodied within the scope of the appended claims.

What is claimed is:

1. A cutting insert for heavy machining operations, comprising:
two opposing end surfaces, two opposing minor side surfaces extending between the two opposing end surfaces, two opposing major side surfaces extending between the end surfaces and the minor side surfaces, each end surface having four corners comprising two lowered corners and two raised corners, the two lowered corners being diagonally opposite each other, the two raised corners being diagonally opposite each other;
two opposing major edges formed at an intersection of each end surface and the major side surfaces, two opposing minor edges formed at an intersection of each end surface and the minor side surfaces, and two opposing corner edges formed at an intersection of each the corner side surfaces and the major side surfaces; and
a major cutting edge formed at an intersection of each major edge and the end surface, and a minor cutting edge formed at an intersection of each minor edge and the end surface, and a corner cutting edge formed at an intersection of the major and minor cutting edges,
wherein each end surface includes a shim abutment surface that extends from one lowered corner to the diagonally opposite lowered corner.

2. The cutting insert of claim 1, wherein the shim abutment surface is in the form of a U-shaped groove having a first side support wall, a second side support wall and a bottom wall with a radius R therebetween.

3. The cutting insert of claim 2, wherein the first and second side support walls are formed at an angle with respect to a central axis A2 passing through the minor side surfaces of the cutting insert.

4. The cutting insert of claim 2, wherein the first and second side support walls are non-parallel with respect to a central axis A2 passing through the minor side surfaces of the cutting insert.

5. The cutting insert of claim 2, wherein the first and second side support walls have a continuously varying width.

6. The cutting insert of claim 2, wherein the bottom wall has a constant width.

7. The cutting insert of claim 1, wherein each minor side surface has 180° rotational symmetry about a central axis A2 passing through the two minor side surfaces.

8. The cutting insert of claim 1, wherein each major side surface has 180° rotational symmetry about a central axis A3 passing through the two major side surfaces of the cutting insert, and wherein a central axis A2 is perpendicular to a central axis A1 passing through the two end surfaces, and the central axis A3 is perpendicular to the central axis A1 and to the central axis A2.

9. The cutting insert of claim 1, wherein the cutting insert further includes four opposed corner side surfaces between the minor and major side surfaces and the end surfaces.

10. The cutting insert of claim 1, wherein a section of the major cutting edge proximate the raised corner constitutes a leading end of the major cutting edge, and wherein a section of the major cutting edge proximate the lowered corner constitutes a trailing end of the major cutting edge.

11. In combination, a cutting insert and a shim for heavy machining operations,
the cutting insert comprising:
two opposing end surfaces, two opposing minor side surfaces extending between the two opposing end surfaces, two opposing major side surfaces extending between the end surfaces and the minor side surfaces, each end surface having four corners comprising two lowered corners and two raised corners, the two lowered corners being diagonally opposite each other, the two raised corners being diagonally opposite each other, each end surface includes a shim abutment surface that extends from one lowered corner to the diagonally opposite lowered corner,
the shim comprising:
two opposing end surfaces, two opposing minor side surfaces extending between the two opposing end surfaces, two opposing major side surfaces extending between the end surfaces and the minor side surfaces, one end surface having four corners comprising two lowered corners and two raised corners, the two lowered corners being diagonally opposite each other, the two raised corners being diagonally opposite each other, one of the end surfaces of the shim having an insert abutment surface that extends entirely from one raised corner to the diagonally opposite raised corner of the shim for contacting the shim abutment surface of the cutting insert.

12. The combination of claim 11, wherein the shim abutment surface \is in the form of a U-shaped groove having a first and second side support walls, and a bottom wall with a radius R between the first and second side support walls, and wherein the insert abutment surface is in the form of a U-shaped protrusion having a substantially planar side support walls, and a substantially planar top wall formed between the two side support walls.

13. The combination of claim 12, wherein the first and second side support walls of the shim abutment surface are formed at an angle with respect to a central axis A2 passing through the minor side surfaces of the cutting insert, and wherein the first and second side support walls of the insert abutment surface are formed at an angle with respect to a central axis A2 passing through the minor side surfaces of the shim.

14. The combination of claim 12, wherein the first and second side support walls are non-parallel with respect to a central axis A2 passing through the minor side surfaces of the cutting insert, and wherein the first and second side support walls are non-parallel with respect to a central axis A2 passing through the minor side surfaces of the shim.

15. The combination of claim 12, wherein the bottom wall of the shim abutment surface and the top wall of the insert abutment surface have a constant width.

16. The combination of claim 11, wherein a section of the major cutting edge proximate the raised corner constitutes a leading end of the major cutting edge, and wherein a section of the major cutting edge proximate the lowered corner constitutes a trailing end of the major cutting edge.

17. A milling cutter, comprising:
a plurality of insert pockets; and
a cutting insert in accordance with claim 1 seated in each of the plurality of insert pockets.

18. The milling cutter of claim 17, further comprising a shim seated in each of the plurality of insert pockets in such a way so as to provide contact along an entire length between the cutting insert and the shim.

19. The milling cutter of claim 18, wherein the cutting insert further includes opposing end surfaces, each end surface having four corners comprising two lowered corners and two raised corners, wherein each end surface includes a shim abutment surface that extends from one lowered corner to the diagonally opposite lowered corner, and wherein the shim further comprises an end surface having four corners comprising two lowered corners and two raised corners, the two lowered corners being diagonally opposite each other, wherein the end surface of the shim has an insert abutment surface that extends entirely from one raised corner to the diagonally opposite raised corner of the shim for contacting the shim abutment surface of the cutting insert.
